(19) United States
(12) Patent Application Publication
(10) Pub. No.: US 2016/0246576 A1
(43) Pub. Date: Aug. 25, 2016

(54) COMPUTER PROGRAM GENERATION

(71) Applicant: CORY Robert, Altrincham Cheshire (GB)

(72) Inventor: Robert Cory, Altrincham Cheshire (GB)

(21) Appl. No.: 15/024,786

(22) PCT Filed: Sep. 23, 2014
(86) PCT No.: PCT/GB2014/052892

§ 371 Date: Mar. 24, 2016

(30) Foreign Application Priority Data
Sep. 27, 2013 (GB) 1317203.6

(51) Int. Cl. G06F 9/44

(52) U.S. Cl. CPC G06F 8/36

(57) ABSTRACT

A method of generating a computer program, the method comprising: receiving input data associated with an environment, the input data comprising first input data and second input data; receiving stored data based upon the environment, said stored data comprising generated computer programs; processing the input data based upon said stored data to generate said computer program, wherein said generated computer program is associated with a relationship between the first input data and second input data; and storing said generated computer program for generation of further computer programs.

The present invention relates to methods of generating computer programs. More particularly, but not exclusively, the present invention relates to automatic generation of computer programs for solving problems.

Computers are widely used to perform useful tasks. Typically a computer is programmed to perform a task by a computer programmer. The computer is provided with a set of instructions that are carried out to cause the computer to perform the task, for example by processing input data to generate output data.

Computers can additionally be programmed to analyse data. For example, computers can be programmed to analyse a set of data and to derive a pattern from the data that may not be obvious to a human.

Genetic programming is a technique that allows computer programs to be automatically generated by analysing input data. For example, a computer can use genetic programming to generate a computer program that satisfies a training set of data. For example, the training set of data may comprise a set of input values and associated output values that are the result of performing a mathematical operation on the input values and using genetic programming a computer can generate a computer program that corresponds to the mathematical operation such that a new input value can be processed using the computer program to generate an output value that corresponds to the result of performing the mathematical operation on the new input value.

Whilst genetic programming is effective in generating computer programs based upon relatively simple input data, there remains a need for techniques that allow computer programs to be generated based upon more complicated input data. The present invention therefore provides improved generation of computer programs.

According to a first aspect of the invention there is provided a method of generating a computer program. The method comprises: receiving input data associated with an environment, the input data comprising first input data and second input data; receiving stored data based upon the environment, the stored data comprising generated computer programs; processing the input data based upon the stored data to generate the computer program, wherein the generated computer program is associated with a relationship between the first input data and second input data; and storing the generated computer program for generation of further computer programs.

The present invention therefore provides a method that allows a computer to reuse computer programs that are generated based upon one set of input data in the generation of computer programs based upon a different set of input data. The stored computer programs are associated with environments and together effectively form a model of the environment that may subsequently be used to generate data associated with objects of the environment, for example associated with change of an object from a first state to a second state or associated with a relationship between first and second objects, based upon the computer programs.

The invention may provide a framework for generating an artificially intelligent computer that is able to learn about its environment in the form of stored computer programs that generalise observed relationships between, and properties of, objects and use the observed relationships and properties in solving problems.

The first input data may be associated with a first state of a first object in the environment and the second input data may be associated with a second state of the first object in the environment. The input data may therefore provide data indicating a relationship between a state of a first object at a first time and a state of the first object at a second time.

Alternatively the first input data may be associated with a first object in the environment and the second input data may be associated with a second object in the environment. The input data may therefore provide data indicating a relationship between objects in the environment.

The environment may for example be an environment associated with objects. For example, the environment may be defined by identified objects.

The input data may comprise a plurality of first input data and associated second input data. For example the input data may provide a plurality of examples of environments and the computer program may provide a computer program that generalises the relationships between objects and or environments in the examples.

Storing the generated computer program may comprise storing data associating the computer program with the environment. The computer program may additionally or alternatively be stored such that the computer program is associated with at least one object of the environment. Storing the generated computer program with an association allows the stored computer programs to be reused in a more effective way.

The stored data may be received based upon the first object and/or second object in addition to based upon the environment. For example, the stored computer programs may be reused in the generation of subsequent computer programs and the associations may be used to reduce the stored computer programs that are reused for any particular set of input data and associated environment and/or objects within the environment.

Processing the input data based upon the stored data may comprise: generating a plurality of computer programs based upon the stored data; for each of the generated computer programs, processing the first input data based upon the computer program to generate respective output data; processing the generated output data and the second input data to determine a fitness associated with each generated computer program; and selecting one of the plurality of computer programs based upon the fitnesses.

Generating a plurality of computer programs based upon the stored data may comprise generating at least one computer program of the plurality of computer programs such that the at least one computer program comprises a generated computer program of the stored data. For example, the at least one computer program may comprise a reference to a generated computer program.

Processing the input data based upon the stored data to generate the computer program may comprise processing the input data using genetic programming techniques. The genetic programming techniques may use a breeding pool of computer programs and the breeding pool of computer programs may comprise computer programs that include instructions comprising a generated computer program of the stored data.

Genetic programming uses an initial breeding pool of computer programs and the initial breeding pool of computer programs may include computer programs that include computer programs of the stored data. The breeding pool of computer programs are then iteratively processed to test the computer programs of the breeding pool using a fitness function that indicates how well the output of the computer program matches the second input data and the best computer programs are selected for the generation of computer programs for the next iteration of the breeding pool. The present invention allows the computer programs of the breeding pool to use computer programs that have previously been generated based upon previous input data and that therefore provide a useful computer program, for example defining a useful relationship between objects or between changes of state of an object. Allowing such useful computer programs to be included in the breeding pool computer programs provides considerable improvements in efficiency in the generation of more complex computer programs and effectively allows the computer to learn based upon data that it receives and processes. The stored data effectively provides a model of an environment that evolves within the computer based upon processed input data.

The plurality of computer programs may be generated based upon the stored data such that a predetermined proportion of the plurality of computer programs comprises a computer program of that stored data. For example, computer programs of the breeding pool may be generated such that a predetermined proportion on average includes a computer program of the stored data.

The generated computer program may comprise at least one of the computer programs of the stored data. As indicated above, such inclusion of computer programs of the stored data in generated computer programs typically increases the efficiency of the generation of the computer program.

The generated computer program may comprise a predetermined number of instructions. For example, instructions of the generated computer program may comprise a binary string.

Instructions of the generated computer program may comprise a reference to a computer program of the stored data. For example, predetermined binary strings may be a reference to a computer program of the stored data. Instructions of computer programs of a breeding pool may be generated by generating a random binary string for each instruction.

The method may further comprise receiving a library comprising a plurality of instructions. The computer program may be generated based upon the library. For example, the initial breeding pool may be generated such that instructions of the library are included in computer programs of the initial breeding pool based upon a predetermined frequency.

The library may be generated based upon the stored data. For example, the library may comprise instructions of generated computer programs and the library may be populated by analysing the generated computer programs to determine instructions that are generally useful.

The method may further comprise processing the input data to determine the environment associated with the input data.

The method may further comprise: receiving further input data associated with the environment, the further input data comprising data indicating a first state of the environment; and processing the further input data and the stored data to generate solution data associated with change of the environment from the first state to a second state. The computer programs that are generated using the invention may therefore be used to solve problems. As indicated above, the computer programs that are stored effectively build a model of an environment and the computer may use the learnt model of the environment to subsequently determine actions that may be carried out to achieve a goal based upon a starting state.

For example, the environment may comprise an object. The environment may for example provide a frame of reference in which one or more objects are defined such that the environment may be said to contain one or more objects. The solution data may comprise instructions for the object for changing the environment and/or objects located within the environment from the first state to the second state. The object may for example be an object associated with the computer, such as an object that the computer can control.

According to a second aspect of the invention there is provided a method of generating solution data associated with change of an environment from a first state to a second state, the method comprising: receiving input data indicating said first state of said environment; receiving stored data based upon the environment, said stored data comprising generated computer programs; processing the input data based upon the stored data to generate the solution data.

As indicated above, stored data may comprise computer programs that are stored based upon previous input data such that the stored data effectively comprises a model of an environment that is learnt from previous input data and the computer may use the stored data associated with the environment to subsequently determine actions that may be carried out to achieve a goal based upon a starting state.

The method may further comprise receiving data associated with the second state. For example, data indicating a goal to be achieved may be provided to the computer. For example, the data indicating a goal to be achieved may comprise a mathematical definition of the second state corresponding to a definition of success that may be used in the generation of the solution data, for example using genetic programming techniques. For example the definition of success associated with the second state may comprise changing the environment to a second state that has associated variables that fall within predetermined bounds. That is, the second state and associated definition of success may not be required to be definite.

The environment may for example comprise an object. For example the environment may provide a frame of reference in which one or more objects are defined such that the environment may be said to contain one or more objects. The input data may indicate a first state of the object within the environment. The solution data may comprise instructions for the object for changing the environment from the first state to the second state.

Aspects of the invention can be combined. It will be appreciated that the features of the first aspect of the invention may be used in the second aspect of the invention.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

The invention will now be described with reference to the accompanying figures in which:

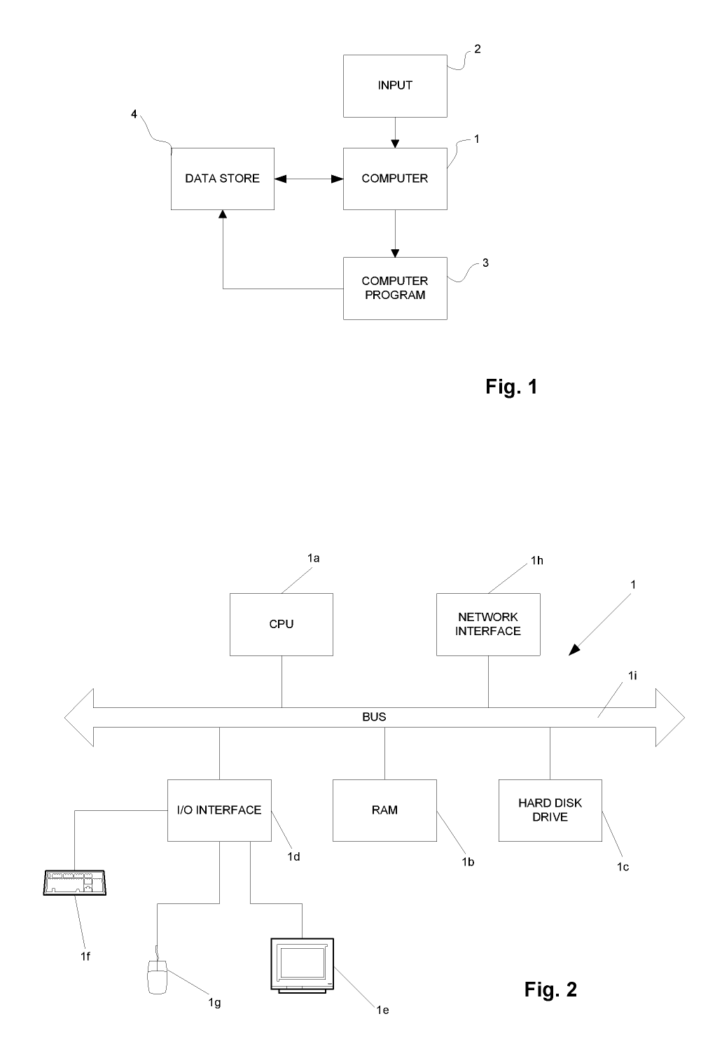

FIG. 1 is a schematic illustration of an arrangement for generation of computer programs in accordance with the invention;

FIG. 2 is a schematic illustration of a computer of FIG. 1;

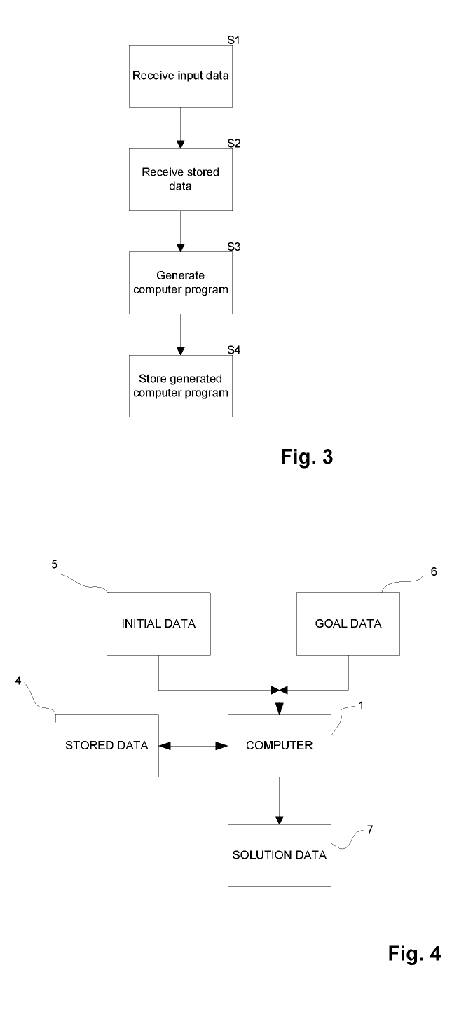

FIG. 3 is a flowchart showing processing to generate a computer program in accordance with the invention;

FIG. 4 is a schematic illustration of a system for solving a problem using computer programs generated using the invention; and

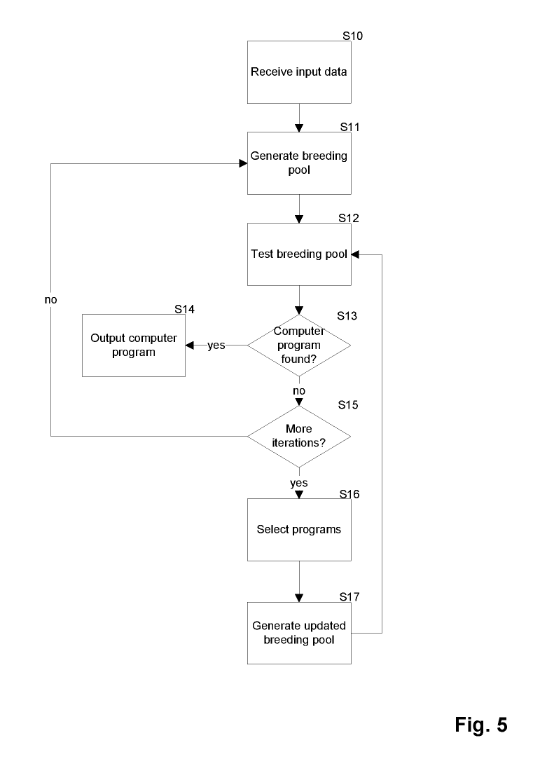

FIG. 5 is a flowchart showing genetic programming to generate a computer program.

Referring to FIG. 1, a computer 1 is arranged to receive input data 2 and to generate a computer program 3 based upon the input data 2. The input data 2 comprises a training set of data associated with an environment and the computer program 3 provides a generalised solution derived based upon the input data 2. For example, the input data may comprise first input data and second input data that are related.

The input data 2 may take any convenient form. For example, the first input data may be a set of input values and the second input data may be a set of associated output values corresponding to change of the input values according to a mathematical function, and the computer program 3 may be a computer program that performs the mathematical function on any further input value, the further input value being either one of the set of input values or any other input value of the same form as the input values of the input data. Alternatively or additionally the input data may be input data from a sensor such as a camera and may comprise a plurality of sets of frames in which objects change from a first state indicated by the first input data to a second state indicated by the second input data, for example moving relative to one another, and the computer program may be a computer program that provides a general solution for the change of the objects in the input data. Example input data is described in further detail below. Alternatively the input data may comprise data associated with a first object in the environment and a second object in the environment, for example associated with a relationship between the first and second object in the environment.

The computer program is therefore a computer program that given input values of the same form as the input values of the input data provides output that has a relationship with the input values that corresponds to the relationship between the input values and associated output values of the input data.

Each set of input data has an associated environment that may comprise a property of the input data or may be determined based upon the input data. For example, where the input data comprises sets of values and the input values indicates change of input values according to a mathematical function the form of the input data may be used to determine a maths environment associated with the input data. Alternatively, where the input data comprises input data from a sensor such as a camera the input data may be first processed to identify the objects using known object recognition techniques and an environment may be determined based upon the objects in the input data. Alternatively or additionally the environment may be provided as part of the input data. That is, the input data may comprise an indication of an environment associated with the input data.

The computer program 3 is generated using genetic programming techniques. Genetic programming is an evolutionary programming technique that for any given problem defined by a set of input data automatically generates a breeding pool comprising a set of computer programs and uses a fitness function to determine how well the computer programs satisfy the set of input data. The breeding pool of computer programs is iteratively modified by cross breeding the computer programs of the breeding pool that best satisfy the set of input data and additionally by introducing mutations into the breeding pool until a computer program satisfies the input data sufficiently well. Genetic programming is described in further detail below with reference to FIG. 5.

The computer 1 is arranged to communicate with a data store comprising stored data 4. The stored data 4 stores data that may be used in the generation of the computer program 3 such as computer programs that are generated by the computer 1. The computer 1 is therefore provided with a set of computer programs that have previously been found to provide a generalised solution to previous associated input data 2 that can be used in the generation of new computer programs that provide a generalised solution to new input data 2. Each computer program 3 that is generated by the computer 1 is stored in the stored data 4. In this way the computer generates a library of computer programs that may be useful in the generation of subsequent computer programs.

Each computer program of the stored data may be associated with an environment that is used to select the computer programs that may be useful in the generation of computer program 3, based upon the environment associated with input data 2.

In some embodiments computer programs of the stored data may additionally be associated with objects. For example, a computer program may be generated that models movement of an object in an environment based upon input data associated with movement of the object in the environment and the generated computer program may be associated with the object. In such an embodiment stored data may be selected based upon an object of the input data 2 and objects associated with computer programs of the stored data 4.

Genetic programming tests a large number of possible computer programs such that by providing a library of computer programs that may be useful in the generation of subsequent computer programs in this way if a stored computer program in the stored data is useful for generating a further computer program then the stored computer program is likely to be included in at least one breeding pool computer program. Whilst a useful computer program that is useful for generating a further computer program may initially form part of a breeding pool computer program that does not provide a solution to the input data, a breeding pool computer program that includes a useful computer program is likely to be selected for cross breeding with other breeding pool computer programs. Once a useful computer program is in the breeding pool, given that it is useful for generating the subsequent computer program, it is likely to spread in the breeding pool and to increase the speed at which a subsequent computer program is generated.

Whilst genetic programming reuses lines of code of computer programs within a breeding pool to generate a computer program that provides a solution to a set of input data, the present invention takes the principle considerably further by using computer programs that provide a generalised solution to previous input data for use in providing a generalised solution to subsequent input data. That is, genetic programming reuses code that may be advantageous over other code but the present invention reuses code that has been previously determined to provide a useful function.

For example, the computer 1 may process input data 3 associated with a distance between two points. The computer 1 may use genetic programming techniques to generate a computer program 3 that provides a general distance function for finding the distance between two objects from the input data 3 and the distance function may be stored in the stored data 4. Subsequent input data 2 may be received that is associated with a speed of an object moving between two points. The computer 1 can use the previously derived distance function to generate the speed function. Whilst the computer 1 does not know that the previously derived distance function is useful in the generation of the speed function, as indicated above, the distance function is likely to be selected and used given that any computer program in the breeding pool that includes the distance function is likely to better satisfy the input data than any computer program that does not include the distance function.

FIG. 2 shows the computer 1 in further detail. It can be seen that the computer comprises a CPU 1a which is configured to read and execute instructions stored in a volatile memory 1b which takes the form of a random access memory. The volatile memory 1b stores instructions for execution by the CPU 1a and data used by those instructions. For example, in use, data such as data received from stored data 4 may be stored in memory 1b.

The computer 1 further comprises non-volatile storage in the form of a hard disc drive 1c. Data such as data received from stored data 4 may be stored in memory 1b. Alternatively stored data 4 may be stored on hard disc drive 1c. That is, stored data 4 may take any convenient form for storing data. The computer 1 further comprises an I/O interface 1d to which are connected peripheral devices used in connection with the computer 1. More particularly, a display 1e is configured so as to display output from the computer 1 such as computer program 3. Input devices are also connected to the I/O interface 1d. Such input devices may include a keyboard 1f and a mouse 1g which allow user interaction with the computer 1. It will be appreciated that the computer may have other input interfaces such as a touch screen. A network interface 1h allows the computer 1 to be connected to an appropriate communications network so as to receive and transmit data from and to other computers. The CPU 1a, volatile memory 1b, hard disc drive 1c, I/O interface 1d, and network interface 1h, are connected together by a bus 1i.

FIG. 3 shows processing carried out to generate a computer program. At step S1 input data is received. The input data comprises data for which it is desirable to generate a computer program that provides a general solution to the data and has an associated environment. At step S2 stored data is received. The stored data comprises a plurality of computer programs generated using the processing of FIG. 3 and each computer program has an associated environment that is used to select the computer programs that may be useful in the generation of the computer program.

At step S3 the computer program is generated from the input data using the stored data. The computer program is generated using genetic programming techniques as are known in the art and as described below. The genetic programming techniques can use the computer programs of the stored data in the genetic programming techniques. For example, an initial breeding pool may be generated such that computer programs of the initial breeding pool includes computer programs of the stored data and/or mutation of breeding pool computer programs may introduce computer programs of the stored data or references to the computer programs of the stored data. Using stored data in this way can significantly improve the speed at which genetic programming generates a computer program that satisfies the input data with respect to a fitness function.

At step S4 the generated computer program is stored in the data store. The generated computer program is stored with an associated environment corresponding to the environment associated with the input data received at step S1 and the associated environment allows the generated computer program to be selected for the generation of subsequent computer programs. The computer program may additionally be stored with an associated object corresponding to an object of the input data associated with the computer program, for example an object of the input data that is modelled by the computer program.

By storing generated computer programs the computer is able to learn based upon previous data that has been received. The stored computer programs make generation of subsequent more complex computer programs less computationally expensive. The present invention may therefore form the basis for a general framework for an artificially intelligent machine that learns about its environment and objects in that environment and may subsequently use what has been learnt to solve problems associated with the environment, as described below.

Selection of stored data based upon environments associated with computer programs of the environment may for example be based upon a hierarchical relationship between environments. For example, the stored data may be trained by providing the stored data with a hierarchical relationship between environments and the hierarchy may be used in the generation of computer programs by allowing computer programs of the stored data having an associated environment that is above an environment associated with the input data in the hierarchy to also be used in the generation of a computer program based upon the input data.

Alternatively or additionally the relationships between environments may be used to control the frequency with which the genetic programming techniques use computer programs. For example, to generate a computer program associated with input data having a first associated environment, computer programs of the stored data having the first associated environment may be used by the genetic programming techniques based upon a first frequency. Computer programs of the stored data having a second associated environment that is closely related to the first associated environment may be used by the genetic programming techniques based upon a second frequency that is less than the first frequency and computer programs of the stored data having a third associated environment that is less closely related to the first associated environment than the second associated environment, as indicated by the hierarchy, may be used by the genetic programming techniques based upon a third frequency that is less than the second frequency.

The input data may take any convenient form that can model an environment. For example, as described above the input data may take the form of a series of associated numbers that are described by a mathematical function, wherein the objects comprise variable objects and solution objects. Alternatively, as indicated above, the input data may take the form of image data generated from a camera and may comprise numerical data that describes objects of the image data. It will of course be appreciated that the input data may take any form that may be processed to generate a computer program that describes the input data.

The input data may for example be pre-processed input data and the pre-processed data may be generated using the processing described above. For example, where the input data is image data the image data may be pre-processed to identify objects in the data and the pre-processed data may be processed using the methods described above to generate a computer program that describes a relationship between objects identified by the pre-processing. It will be appreciated that the pre-processing may be carried out in any convenient way. For example, the image data may be pre-processed using known object recognition techniques. Alternatively or additionally the image data may be pre-processed to identify objects using genetic programming techniques using stored data based upon previously processed image data. For example the computer 1 may receive as input data 2 a plurality of training images of an object and the output computer program 3 may comprise a model of the object that represents the variation of the object in the input data. Alternatively the input data may be processed to generate models of objects in any convenient way such as using active appearance modelling as is known in the art.

The computer 1 may use the stored data for problem solving. For example, as illustrated in FIG. 4, the computer may further be arranged to receive initial data 5 associated with an initial state of objects in an environment and goal data 6 associated with a target state of objects in the environment. The computer 1 of FIG. 4 is arranged to generate solution data 7 comprising one or more possible actions that allow change of the objects in the environment between the state associated with the initial data and the state associated with the goal data. The solution data 7 is generated based upon the stored data 4. For example, as described above the stored data 4 may comprise a plurality of computer programs associated with objects and environments.

The computer programs associated with objects provide functions associated with change of the objects based upon previous input data and therefore model possible change of the objects between first and second states and the computer programs associated with environments provide functions associated with change of the environment and objects within the environment between states. The computer 1 can therefore process the computer programs of the stored data 4 that are associated with the environment and the objects of the initial data to determine possible change of the objects within the environment to determine how to achieve the goal.

The generated computer programs that are stored as part of the stored data 4 therefore effectively provide the computer 1 with a model of the environments and objects and interaction between the objects in the environments that can be built based upon observed data. In this way the computer 1 is effectively able to learn about environments and can reapply what is learnt to novel situations described by the initial data and the goal data.

It has been described above that the input data 2 may for example be image data. For example, the computer 1 may be connected to a camera that provides image data to the computer and the computer may be arranged to process the image data to generate stored data describing relationships between objects of the image data. The computer 1 may additionally comprise other input and/or output devices. For example, the computer 1 may be arranged to control machinery or to provide output to a user indicating a possible course of action. The computer 1 may additionally be arranged to receive input from the machinery such that the computer 1 receives as input data associated with control of the machinery and generate output data associated with control of the machinery such that the computer 1 can automatically control the machinery to perform actions associated with the input data or can provide output to a user indicating suggested control of the machine. Further examples of use of the present invention are described below.

The machinery may for example be industrial machinery that is arranged to perform a task on objects in an environment and the computer 1 may receive training data generated by causing the machinery to perform the task on the objects. The computer 1 processes the training data to generate a computer program that generalises the task and the generated computer program may be used to process initial data associated with an initial state of the objects before the task has been performed and goal data associated with completing the task and to control the machinery to perform the task on the objects in the environment.

It will be appreciated that the methods described above provide a general framework for training a computer to perform any actions based upon input data. The machinery may for example be a robotic grasping device that allows the computer 1 to interact with objects in an environment. The following provides a non-exhaustive list of tasks for which the computer 1 may be used: control of packaging machinery, for example control of a sardine packing machine to minimise the use of oil; control of pattern cutting to minimise waste; quality control to automatically detect and reject items that are not of a sufficient quality; traffic light control, for example to optimise traffic movement; optimised control of a rockets in a space ship to achieve a particular result, for example to control movement of the space ship to a destination; automatic car parking; game playing such as chess or draughts; vehicle auto pilot, for example aeroplane or boat control. The computer may provide suggestions to a user such as, for example: indication of a shot in a ball game to achieve a desired result, for example a direction to strike a ball in a game of snooker or billiards to pot a ball; courses of action on a battlefield, for example movement of troops; suggestions in a navigation system; design of drugs to solve a particular problem; and layout of a garden.

The invention provides a way of constructing models about a number of different environments together with associations between the environments and the models can be used to solve complex, high level problems. Because the computer generates computer programs automatically the methods described herein provide a black box way of building an artificially intelligent entity that automatically learns about objects and their interactions, as well as automatically learning associations between objects and environments that can be transferred to new situations and environments.

The data store of the present invention typically comprises computer programs associated with environments and objects and the computer programs define properties and methods associated with the environments and objects. The present invention may therefore be considered as a type of object oriented programming in which computer programs are automatically generated based upon other objects and methods using input data. The methods provide a user input driven methodology for computer program generation compared to the programmer driven methodology of standard objected oriented programming techniques.

It has been described above that genetic programming techniques are used to generate a computer program. FIG. 5 illustrates genetic programming techniques at a high level, however it will be appreciated that any suitable genetic programming techniques may be used.

Referring to FIG. 5, at step S10 input data is received. As described above, the input data comprises a training set of data associated with an environment. At step S11a breeding pool of computer programs is generated. The breeding pool may be generated such that each computer program of the breeding pool comprises a predetermined or user selected number of lines of instructions, which allows the computer program modifications subsequently carried out to be simplified.

Each computer program of the breeding pool comprises a plurality of instructions that are selected randomly. The randomly selected instructions may comprise stored data and may be selected based upon an environment associated with the input data as described above. For example, each instruction of each computer program may comprise a randomly generated binary string comprising a predetermined number of bits, for example a 64 bit string, and predetermined randomly generated binary strings may comprise a reference to stored data such as a computer program of data store 2 of FIG. 1. For example, each binary string having a predetermined bit sequence may be a reference to a computer program of the stored data. The binary string may be used to control the frequency with which a computer program of the stored data is included in a computer program of the breeding pool, for example based upon the likelihood of a binary string randomly comprising a reference to a computer program of the stored data.

Alternatively or additionally the randomly generated binary strings may comprise useful lines of code from a library of useful lines of code other than predetermined computer programs, or reference to such lines of code, for example lines of code that initialise variables of the computer program. The library of useful lines of code may for example be generated based upon analysis of previously generated computer programs such as computer programs of the data store 2.

At step S12 the breeding pool is tested to determine how well the computer programs of the breeding pool satisfy the input data, based upon a fitness function. In general terms the fitness function provides an output value indicative of how closely a computer program models the environment and/or objects in the environment and is based upon processing the first input data using the computer program and determining how closely the output of the computer program matches the second input data.

At step S13 a test is carried out to determine if a computer program of the breeding pool satisfies the input data sufficiently well and if it is determined that a computer program satisfies the input data sufficiently well then the computer program is output at step S14. Determining whether a computer program satisfies the input data sufficiently well may for example be based upon a threshold value associated with the output of the fitness function such that the output of the computer program may not be required to exactly match the second input data.

If no computer program satisfies the input data sufficiently well then at step S15 it is determined whether more iterations are required using the current breeding pool, for example based upon a counter. If it is determined that more iterations are required then at step S16 computer programs of the breeding pool that are determined to best satisfy the input data are selected based upon the output of the fitness function associated with each computer program. For example, a predetermined percentage of the computer programs may be selected that best satisfy the input data.

At step S16 an updated breeding pool is generated by cross breeding computer programs of the breeding pool and/or by mutating computer programs of the breeding pool. Cross breeding of computer programs may be carried out for example by randomly combining two computer programs of the breeding pool. For example a new computer program may be generated based upon two computer programs of the breeding pool by randomly selecting instructions of each of the two computer programs and combining the randomly selected instructions and/or by merging instructions of the two computer programs.

For example, as described above each computer program of the breeding pool may comprise a plurality of lines of code, each line of code being represented by a binary string. The computer programs may be cross bred by randomly selecting binary strings from each of the computer programs and recombining the randomly selected binary strings. The computer programs may additionally or alternatively be combined by merging instructions of two computer programs by combining binary strings representing an instruction of each of the computer programs to generate a new binary string comprising a further instruction. The computer programs may additionally or alternatively be modified by randomly changing the value of bits of one or more binary strings. It will be appreciated that binary strings that are generated using the modifications described above may result in a binary string representing one of the computer programs of the data store 2 such that the modifications provide a way in which methods of the data store 2 can be introduced into computer programs of the breeding pool after initialisation of the breeding pool.

The processing of steps S12 to S17 are then repeated until either a computer program that satisfies the input data sufficiently well is output at step S14 or until it is determined at step S15 that no more iterations are to be performed based upon the current breeding pool. If it is determined at step S15 that no more iterations are to be performed then processing proceeds to step S11 where a new breeding pool is generated.

It will be appreciated that the processing of steps S12 to S17 is typically repeated a large number of times in order to allow the breeding pool to evolve towards a computer program that satisfies the input data sufficiently well. However the test of step S15 allows breeding pools that are not able to generate a computer program that satisfies the input data sufficiently well to be reset.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form for a component of the system has been described, it will be appreciated that such component may be carried out in any suitable form arranged to provide a corresponding function.

1. A method of generating a computer program, the method comprising:
receiving input data associated with an environment, the input data comprising first input data and second input data;
receiving stored data based upon the environment, said stored data comprising generated computer programs;
processing the input data based upon said stored data to generate said computer program, wherein said generated computer program is associated with a relationship between the first input data and second input data; and
storing said generated computer program for generation of further computer programs.

2. The method of claim 1, wherein the first input data is associated with a first state of a first object in the environment and the second input data is associated with a second state of the first object in the environment.

3. The method of claim 2, wherein storing said generated computer program comprises storing data associating said computer program with said first object.

4. The method of claim 1, wherein the first input data is associated with a first object in the environment and the second input data is associated with a second object in the environment.

5. The method of claim 4, wherein storing said generated computer program comprises storing data associating said computer program with said first object and/or said second object.

6. The method of claim 2, wherein said stored data is received based upon said first object and/or said second object.

7. The method of claim 1, wherein storing said generated computer program comprises storing data associating said computer program with said environment.

8. The method of claim 1, wherein said generated computer program comprises at least one of said computer programs of said stored data.

9. The method of claim 1, wherein processing the input data based upon said stored data comprises:
generating a plurality of computer programs based upon the stored data;
for each of said generated computer programs, processing the first input data based upon the computer program to generate respective output data;
processing the generated output data and the second input data to determine a fitness associated with each generated computer program; and
selecting one of said plurality of computer programs based upon said fitnesses.

10. The method of claim 9, wherein generating a plurality of computer programs based upon the stored data comprises:
generating at least one computer program of said plurality of computer programs such that said at least one computer program comprises a generated computer program of said stored data.

11. The method of claim 9, wherein said plurality of computer programs are generated based upon the stored data such that a predetermined proportion of said plurality of computer programs comprises a computer program of said stored data.

12. The method of claim 1, wherein said generated computer program comprises a predetermined number of instructions.

13. The method of claim 1, wherein instructions of said generated computer program comprise a binary string.

14. The method of claim 1, wherein instructions of said generated computer program comprise a reference to a computer program of said stored data.

15. The method of claim 1, further comprising receiving a library comprising a plurality of instructions, wherein said computer program is generated based upon said library.

16. The method of claim 15, wherein said library is generated based upon said stored data.

17. The method of claim 1, further comprising processing said input data to determine said environment associated with said input data.

18. The method of claim 1, wherein processing the input data based upon said stored data to generate said computer program comprises processing the input data using genetic programming techniques, wherein said genetic programming techniques use a breeding pool of computer programs and wherein said breeding pool of computer programs comprises computer programs that include instructions comprising a generated computer program of said stored data.

19. The method of claim 1, further comprising:
receiving further input data associated with the environment, the further input data comprising data indicating a first state of the environment; and
processing the further input data and the stored data to generate solution data associated with change of the environment from the first state to a second state, wherein the environment comprises an object and said solution data comprises instructions for said object for changing said environment from the first state to the second state.

20. (canceled)

21. (canceled)

22. A non-transitory computer readable storage medium, having instructions recorded thereon that, when executed by a computing device, cause the computing device to perform operations comprising:
receiving input data associated with an environment, the input data comprising first input data and second input data;
receiving stored data based upon the environment, said stored data comprising generated computer programs;
processing the input data based upon said stored data to generate said computer program, wherein said generated computer program is associated with a relationship between the first input data and second input data; and
storing said generated computer program for generation of further computer programs.

23. A computer apparatus for generating a computer program comprising:
a memory storing processor readable instructions; and
a processor arranged to read and execute instructions stored in said memory; wherein said processor readable instructions comprise instructions arranged to control the computer to carry out a method comprising:
receiving input data associated with an environment, the input data comprising first input data and second input data;
receiving stored data based upon the environment, said stored data comprising generated computer programs;
processing the input data based upon said stored data to generate said computer program, wherein said generated computer program is associated with a relationship between the first input data and second input data; and
storing said generated computer program for generation of further computer programs.

24. A method of generating solution data associated with change of an environment from a first state to a second state, the method comprising:
receiving input data indicating said first state of said environment;
receiving stored data based upon the environment, said stored data comprising generated computer programs;
processing the input data based upon said stored data to generate said solution data.

25. The method of claim 24, wherein the environment comprises an object.

26. The method of claim 24, wherein said input data indicates a first state of said object within said environment and said solution data comprises instructions for said object for changing said environment from the first state to the second state.

27. (canceled)

28. The method of claim 24, further comprising receiving data associated with said second state.

29-31. (canceled)
